(19) United States
(12) Patent Application Publication
(10) Pub. No.: US 2014/0185177 A1
(43) Pub. Date: Jul. 3, 2014

(54) DAMPNESS PROTECTIVE APPARATUS AND ELECTRONIC DEVICE USING SAME

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventor: JIAN LI, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/098,600

(22) Filed: Dec. 6, 2013

(30) Foreign Application Priority Data
Dec. 27, 2012 (CN) 2012105776433

(51) Int. Cl. H02H 5/08

(52) U.S. Cl. CPC H02H 5/083
USPC 361/115

(57) ABSTRACT

A dampness protective apparatus for an electronic device includes a humidity sensor, a processor and a controller. The humidity sensor detects an internal humidity of the electronic device. The processor is electrically connected to the humidity sensor, and determines whether the internal humidity of the electronic device is greater than or equal to a reference humidity. The controller is electrically connected to the processor and controls a circuit board in the electronic device to be powered off when the processor determines that the internal humidity of the electronic device is greater than the reference humidity.

### CROSS-REFERENCE TO RELATED APPLICATIONS

This application claims all benefits accruing under 35 U.S.C. §119 from China Patent Application No. 201210577643.3, filed on Dec. 27, 2012 in the China Intellectual Property Office, the content of which is hereby incorporated by reference.

### BACKGROUND

1. Technical Field

The present disclosure relates to a dampness protection technologies, and more particularly, to a dampness protective apparatus for implementing power control when an electronic device suffering high humidity.

2. Description of Related Art

Electronic devices may be damaged when being subjected to high humidity environment. For example, an electrical circuitry of a circuit board of the electronic device may suffer short circuit when air within the electronic device is damp. This may cause some electronic components in the circuit board to be burned or even destroy the whole electronic devices.

What is needed is to provide a means that can overcome the above-described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic block diagram of an electronic device according to an embodiment of the present disclosure, the electronic device including a dampness protective apparatus.

FIG. 2 is schematic block diagram of the dampness protective apparatus of the electronic device of FIG. 1.

### DETAILED DESCRIPTION

Reference will now be made to the drawings to describe various embodiments in detail.

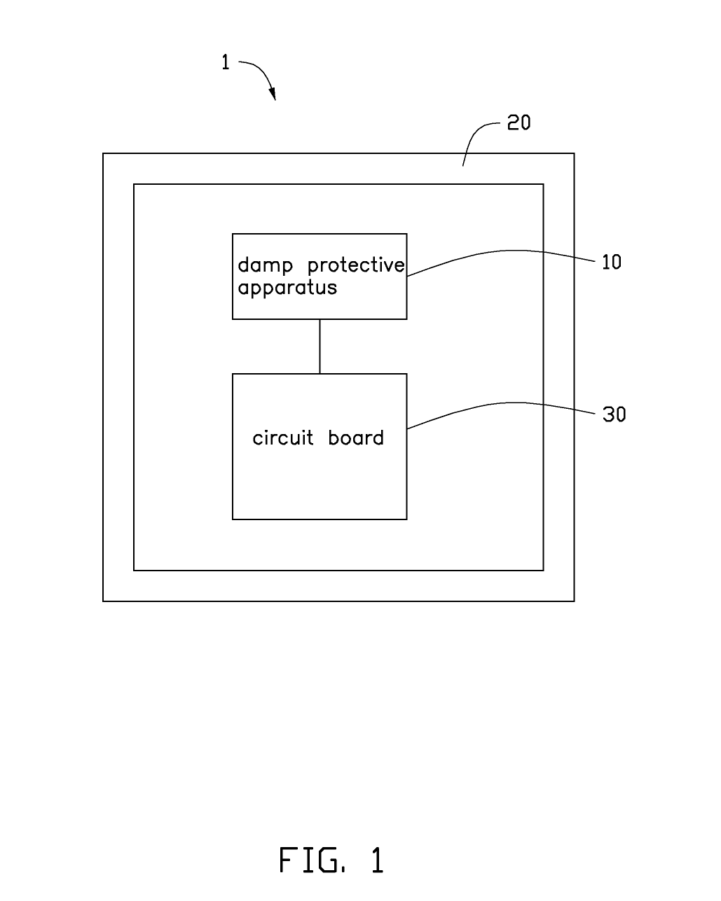

An electronic device according to an embodiment of the present disclosure is illustrated in FIG. 1, the electronic device 1 may be a computer, a television, a mobile phone, or the like. The electronic device 1 includes a dampness protective apparatus 10, a shell 20 and a circuit board 30. The dampness protective apparatus 10 and the circuit board 30 are received in the shell 20, and the dampness protective apparatus 10 is electrically connected to the circuit board 30. For example, the electronic device 1 may be a computer and the circuit board 30 is a motherboard in the computer; alternatively, the electronic device 1 may be a television and the circuit board 30 may be a power board or a control board in the television.

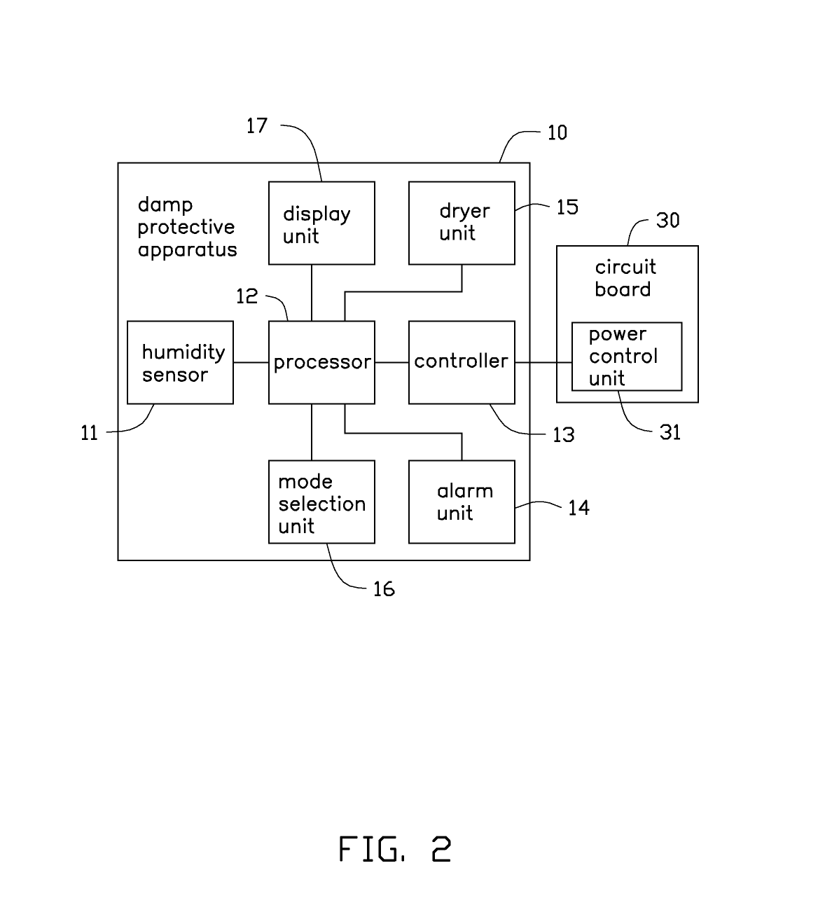

FIG. 2 schematically illustrates a block diagram of the dampness protective apparatus 10 of the electronic device 1 of FIG. 1. The dampness protective apparatus 10 includes a humidity sensor 11, a processor 12, a controller 13, an alarm unit 14, a dryer unit 15, a mode selection unit 16 and a display unit 17. The humidity sensor 11, the controller 13, the alarm unit 14, the drying unit 15, the mode selection unit 16 and the display unit 17 are all electrically connected to the processor 12, and the controller 13 is further electrically connected to a power control unit 31 of the circuit board 30. The processor 12, the controller 13 and the mode selection unit 16 may be hermetically encapsulated, while the humidity sensor 11 is exposed to the internal environment of the shell 20.

The mode selection unit 16 provides a human-computer interaction (HCI) interface for a user, the user can use the mode selection unit 16 to select an operation mode of the dampness protective apparatus 10. In one embodiment, the dampness protective apparatus 10 may have an automatic protective mode and a manual protective mode. When the automatic protective mode is selected by use of the mode selection unit 16, the dampness protective apparatus 10 is automatically started up when the electronic device 1 is powered on. When the manual protective mode is selected, the dampness protective apparatus 10 is not started up unless the dampness protective apparatus 10 is manually enabled.

The humidity sensor 11 may be an infrared (IR) type humidity sensor or an ultrasonic type humidity sensor for detecting an internal humidity of the electronic device 1. For example, the humidity sensor 11 may detect an air humidity within the shell 20 and take the air humidity as the internal humidity of the electronic device 1, alternatively, the humidity sensor 11 may also detect a humidity of an inner wall of the shell 20 or detect a humidity of a surface of the circuit board 30, and takes the detected humidity of the inner wall of the shell 20 or the detected humidity of the surface of the circuit board 30 as the internal humidity of the electronic device 1.

The processor 12 receives the internal humidity of the electronic device 1 from the humidity sensor 11, and compares the internal humidity with a reference humidity. The reference humidity may be a predetermined threshold value. When the internal humidity is greater than or equal to the reference humidity, the processor 12 determines that an operation environment of the circuit board 30 is too damp and correspondingly outputs a first indicating signal to the controller 13, the alarm unit 14, and the dryer unit 15. Otherwise, the processor 12 determines that the operation environment is suitable for the circuit board 30 and correspondingly outputs a second indicating signal to the controller 13, the alarm unit 14, and the dryer unit 15. Moreover, the processor 12 may also output internal humidity information such as a humidity value to the display unit 17.

The controller 13 receives the first indicating signal or the second indicating signal from the processor 12, and correspondingly outputs a first control signal or a second control signal to the power control unit 31 of the circuit board 30, so as to control a power state of the circuit board 30.

Specifically, when the controller 13 receives the first indicating signal which indicates the internal humidity of the electronic device 1 is greater than or equal to the reference humidity, the controller 13 generates and outputs the first control signal to the power control unit 31. In response to the first control signal, the power control unit 31 further controls the circuit board 30 to be powered off or to maintain a power-off state of the circuit board 30 if the circuit board 30 is not yet powered on, so as to protect electronic components in the circuit board 30 from short circuiting. When the controller 13 receives the second indicating signal which indicates the internal humidity of the electronic device 1 is less than the reference humidity, the controller 13 generates and outputs the second control signal to the power control unit 31. In response to the second control signal, the power control unit 13 controls the circuit board 30 to be powered on or to maintain the power-on state.

The alarm unit 14 receives the first indicating signal or the second indicating signal from the processor 12, and when the first indicating signal is received, the alarm unit 14 raises an alarm to inform the user of that the internal humidity of the electronic device 1 is high. The alarm unit 14 may be a buzzer, an alarm lamp or a vibrator.

The dryer unit 15 receives the first indicating signal or the second indicating signal from the processor 12, and when the first indicating signal is received, the dryer unit 15 is activated and implements a drying process to reduce the internal humidity of the electronic device 1. The dryer unit 15 may be a dryer lamp, a dryer fan, or a combination thereof.

In particular, after the drying process is started, the humidity sensor 11 may keep on detecting the internal humidity of the electronic device 1. upon the condition that the internal humidity drops to the reference humidity, the processor 12 changes the output thereof into the second indicating signal. Thereafter, the controller 13 outputs the second control signal to the power control unit 31, so as to control the circuit board 30 to be re-powered on. moreover, the alarm unit 14 and the dryer unit 15 stop the alarm and the drying process, respectively.

The display unit 17 receives the internal humidity information from the processor 12, and displays visible information such as the humidity value for the user. As such, the user can be aware of the internal humidity of the electronic device 1, and make some necessary manual operation according to the internal humidity.

The above-described electronic device 1 utilizes the dampness protective apparatus 10 to control the power state of the circuit board 30 in accordance to the internal humidity of the electronic device 1, therefore, the circuit board 30 may be automatically powered off when the internal humidity of the electronic device 1 is high. This can prevent the electronic components in the circuit board 30 from being short circuited or burned, and protect the electronic device 1.

It is to be understood that even though numerous characteristics and advantages of the present embodiments have been set forth in the foregoing description, together with details of the structures and functions of the embodiments, the disclosure is illustrative only, and that changes may be made in detail, especially in matters of shape, size, and arrangement of parts, within the principles of the embodiments, to the full extent indicated by the broad general meaning of the terms in which the appended claims are expressed.

What is claimed is:

1. A dampness protective apparatus, comprising:
a humidity sensor detecting an internal humidity of an electronic device, a processor electrically connected to the humidity sensor, and determining whether the internal humidity of the electronic device is greater than or equal to a reference humidity, and
a controller electrically connected to the processor, and controlling a circuit board in the electronic device to be powered off when the processor determines that the internal humidity of the electronic device is greater than the reference humidity.

2. The dampness protective apparatus of claim 1, wherein the humidity sensor is an infrared type humidity sensor or an ultrasonic type humidity sensor.

3. The dampness protective apparatus of claim 2, wherein the humidity sensor detects an air humidity within a shell in which the circuit board is received and takes the detected air humidity as the internal humidity of the electronic device.

4. The dampness protective apparatus of claim 2, wherein the humidity sensor detects a humidity of an inner wall of a shell in which the circuit board is received and takes the detected humidity as the internal humidity of the electronic device.

5. The dampness protective apparatus of claim 2, wherein the humidity sensor detects a humidity of a surface of the circuit board and takes the detected humidity as the internal humidity of the electronic device.

6. The dampness protective apparatus of claim 1, wherein the processor outputs a first indicating signal to the controller upon determining that the internal humidity of the electronic device is greater than or equal to the reference humidity, and outputs a second indicating signal to the controller upon determining that the internal humidity of the electronic device is less than the reference.

7. The dampness protective apparatus of claim 6, wherein the controller generates and outputs a first control signal to the circuit board upon receiving the first indicating signal from the processor, the first control signal is configured to control the circuit board to be powered off or to maintain a power-off state of the circuit board.

8. The dampness protective apparatus of claim 7, wherein the controller generates and outputs a second control signal to the circuit board upon receiving the second indicating signal from the processor, the second control signal is configured to control the circuit board to be powered on or to maintain a power-on state of the circuit board.

9. The dampness protective apparatus of claim 6, further comprising an alarm unit electrically connected to the processor, wherein the alarm unit is configured to raise an alarm when receiving the first indicating signal from the processor.

10. The dampness protective apparatus of claim 6, further comprising a dryer unit electrically connected to the processor, wherein the dryer unit is configured to implement a drying process when receiving the first indicating signal from the processor.

11. The dampness protective apparatus of claim 10, wherein after the drying process is started, the humidity sensor keeps on detecting the internal humidity of the electronic device, and when the internal humidity drops to the reference humidity, the processor changes to output the second indicating signal to the controller, such that the controller controls the circuit board to be re-powered on.

12. The dampness protective apparatus of claim 6, further comprising a display unit electrically connected to the processor, wherein the display unit is configured to receive internal humidity information from the processor and display the internal humidity information.

13. The dampness protective apparatus of claim 6, further comprising a mode selection unit electrically connected to the processor, wherein the mode selection unit is configured to provide a human-computer interaction interface for a user that allows the user to use the mode selection unit to select an operation mode of the dampness protective apparatus.

14. The dampness protective apparatus of claim 13, wherein when an automatic protective mode is selected via the mode selection unit, the dampness protective apparatus is automatically started up when the electronic device is powered on, and when a manual protective mode is selected via the mode selection unit, the dampness protective apparatus is not started up unless the dampness protective apparatus is manually enabled.

15. An electronic device, comprising:
a shell,
a circuit board received in the shell, the circuit board configured for installing a plurality of electronic components, and
a dampness protective apparatus received in the shell and electrically connected to the circuit board, the dampness protective apparatus comprising:
a humidity sensor for detecting an internal humidity of the electronic device, a processor for determining whether the internal humidity of the electronic device is greater than or equal to a reference humidity, and
a controller for controlling the circuit board to be powered off when the internal humidity of the electronic device is greater than the reference humidity.

16. The electronic device of claim 15, wherein the processor outputs a first indicating signal to the controller upon determining that the internal humidity of the electronic device is greater than or equal to the reference humidity, and outputs a second indicating signal to the controller upon determining that the internal humidity of the electronic device is less than the reference.

17. The electronic device of claim 16, wherein the circuit board comprises a power control unit electrically connected to the controller of the dampness protective apparatus.

18. The electronic device of claim 17, wherein the controller outputs a first control signal to the power control unit upon receiving the first indicating signal from the processor, and in responsive to the first control signal, the power control unit controls the circuit board to be powered off or to maintain a power-off state of the circuit board.

19. The electronic device of claim 17, wherein the controller outputs a second control signal to the power control unit upon receiving the second indicating signal from the processor, and in responsive to the second control signal, the power control unit controls the circuit board to be powered on or to maintain a power-on state of the circuit board.

20. The electronic device of claim 15, wherein the dampness protective apparatus further comprises a mode selection unit electrically connected to the processor, the mode selection unit is configured to provide a human-computer interaction interface for a user such that the user is capable of using the mode selection unit to select an operation mode of the dampness protective apparatus.
